(19) United States
(12) Patent Application Publication
(10) Pub. No.: US 2015/0018195 A1
(43) Pub. Date: Jan. 15, 2015

(54) CERAMIC FOAM

(71) Applicant: Joris Laarman Studio BV, Amsterdam (NL)

(72) Inventor: Marjan Van Aubel, Amsterdam (NL)

(73) Assignee: Joris Laarman Studio BV, Amsterdam (NL)

(21) Appl. No.: 14/385,118

(22) PCT Filed: Mar. 13, 2013
(86) PCT No.: PCT/NL2013/050165

§ 371 Date: Sep. 12, 2014

(30) Foreign Application Priority Data
Mar. 13, 2012 (EP) 12159289.3

(51) Int. Cl. C04B 33/32; C04B 38/02

(52) U.S. Cl. CPC C04B 33/323; C04B 38/02; C04B 2235/447; C04B 2235/349; C04B 2235/3418; C04B 2235/606
USPC 501/85; 264/43

(57) ABSTRACT

The invention relates to a method for preparing a ceramic material, in particular porcelain, having a porous, foam-like structure, comprising the steps of providing a clay composition comprising kaolin clay; alkali metal salt and/or alkaline earth metal salt, or a mixture thereof; a plastic mineral clay; and a frit; and water; shaping said composition in a mould; drying said composition in said mould by subjecting it to temperatures below 140° C.; firing said composition in said mould by subjecting it to temperatures within the range of 700-1200° C. The invention also pertains to objects made of this foamed ceramic material.

### FIELD OF THE INVENTION

The present invention relates to a method for preparing a ceramic material, in particular porcelain, having a porous, foam-like structure as well as to objects made of this foamed ceramic.

### BACKGROUND OF THE INVENTION

Several methods for preparing ceramic foams are known in the art. U.S. Pat. No. 4,424,280 discloses a process for preparing a clay foam wherein a slip is prepared, optionally comprising a foaming agent, which is mechanically stirred while controlled quantities of a gas are introduced, followed by drying and firing. This results in a foam having a density between about 0.3-1.2 g/cm³, which can suitably be used as an acoustic or thermal insulation material.

U.S. Pat. No. 4,803,025 and U.S. Pat. No. 5,279,737 are examples of processes wherein a foamed polymer shape is impregnated with an aqueous slurry of a ceramic composition, followed by heating the slurry-impregnated polymer shape to a temperature sufficient to remove said organic polymer, and finally firing the ceramic structure at elevated temperature. Ceramic composite structures are obtained having interconnected porosity and controlled pore size, suitable as filter for molten metal, gas or liquid filtration or as a substrate for catalysts.

U.S. Pat. No. 4,447,548 describes a method for producing a high porosity ceramic material comprising wetting finely divided, non-crystalline, amorphous silica with a wetting agent, such as water; combining the wetted silica with a ceramic slip to produce a mixture; and remove the majority of the wetting agent by firing to produce a solid, low-density, highly porous (open-cell) bisque, which is used as a scent carrier.

A disadvantage of the methods according to the prior art is that they rely on special equipment, including mechanical stirrers and gas inlets, and/or the use of foaming aids or ‘sacrificial’ porous organic pre-structures, which makes these methods complex, expensive and potentially polluting. Another aspect of the porous ceramics known in the art is that these are primarily developed for a variety of practical purposes, including the filtration of molten metals and catalysis as mentioned above; as such, they are commonly characterized by having microporous structure, with pore sizes corresponding to at least 15 pores per inch (ppi). Conversely, the development of macroporous ceramic materials that also feature an attractive appearance has so far received little attention in the art. In addition, attention has primarily been focused on (macro)porous systems featuring an open-cell structure, i.e. susceptible to the influence or absorption of liquids such as water. Hence, there is a need in the art for novel methods for preparing porous ceramic materials, which methods are straightforward and consume as little auxiliary substances as possible. There is also a need in the art for the development of porcelain-type ceramic materials that feature a macroporous, foam-like structure that may find application in decorative purposes or as building elements.

### SUMMARY OF THE INVENTION

In view of the above objects, the inventors have now found that a highly porous ceramic material can be prepared by subjecting a particular clay composition to a specific temperature treatment, which is characterized by a consecutive drying, firing and optionally temperature maintaining step at increasing temperatures. This combination of clay composition and temperature treatment causes said composition to ‘rise’ in a manner similar to the rising of bread dough. In the present process though, the volume of the ceramic composition increases to 300-500% of its original volume, depending on the amount of material used and the dimensions of the mould. This results in a transparent or translucent porcelain-type ceramic material having an attractive foam-like or spongy structure. The method of the invention has several advantages over prior art methods. Firstly, since air is not introduced into the clay composition mass during an agitation step, that is, the mass is not pre-foamed prior to transfer to the kiln, no special additional equipment or controls are needed for the mixing step other than an ordinary blunger as is commonplace in the art. Secondly, no processing aids such as foaming agents, foaming aids and surface-active substances for enhancing air entrapment into the mass are required. The method of the invention furthermore does not employ disposable foamed polymer shapes that serve as a template for impregnation with the ceramic slurry. As such, the method is straightforward, relatively inexpensive and environmentally clean.

### DESCRIPTION OF THE FIGURES

FIG. 1 shows a photograph of a sphere made of the porcelain foam according to the invention (diameter: about 15 cm).

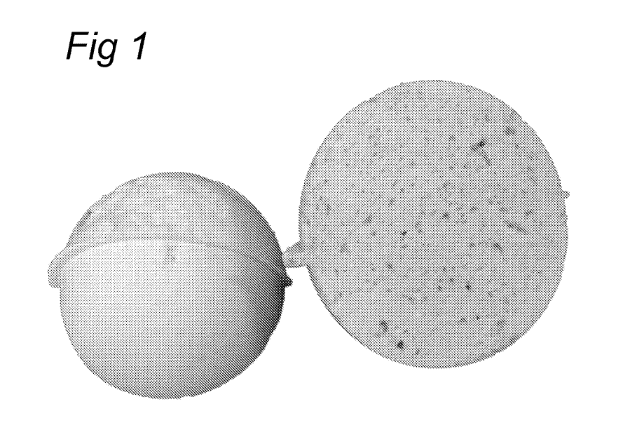

FIG. 2 shows a photograph of a cross-section of “bread bun” made of the porcelain foam according to the invention (dimensions: about 15×15×5 cm³).

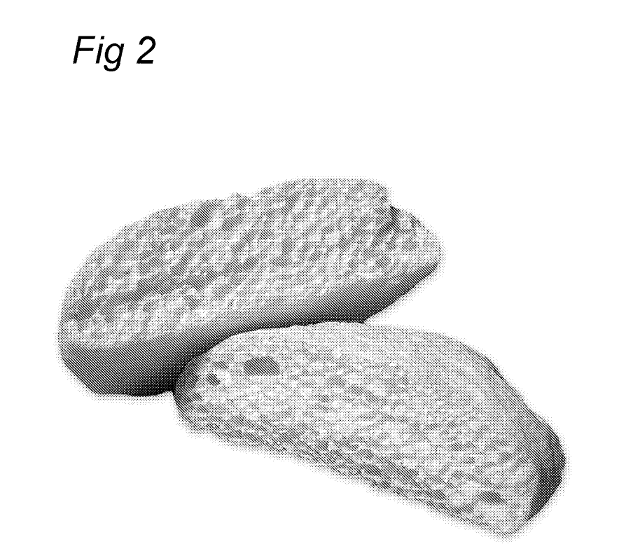

### DETAILED DESCRIPTION OF THE INVENTION

The invention thus pertains in a first aspect to a method for the preparation of a ceramic foam, comprising the steps of
a) providing a clay composition comprising
   i) 5-25 wt % kaolin;
   ii) 10-30 wt % of one or more alkali metal salts and/or alkaline earth metal salts;
   iii) 0.1-5 wt % plastic mineral clay; and
   iv) 40-75 wt % frit;
wherein all weight percentages (wt %) are based on the total weight of solids; and 10-50 wt % water, based on the total weight of solids;
b) shaping said composition in a mould;
c) drying said composition in said mould by subjecting it to temperatures below 140° C.;
d) firing said composition in said mould by subjecting it to temperatures within the range of 700-1200° C.

In this method, no processing aids such as foaming agents, foaming aids and surface-active substances for enhancing air entrapment into the mass are required. This method furthermore does not employ disposable foamed polymer shapes that serve as a template for impregnation with the ceramic slurry. Without wishing to be bound to any theory, it is believed that the combination of the clay composition and temperature treatment according to the invention causes the decomposition of one part as well as melting or softening of another part of the constituents of said clay composition, thereby forming one or more gaseous components that are at least partially trapped in a multitude of cavities enclosed by the molten clay composition, after which the resulting foamed structure is fixated by prolonged heat treatment, also referred to as “curing”, at elevated temperature. This results in a strong, hard, lightweight and transparent porcelain-type ceramic material featuring a macroporous, foam-like structure and a smooth surface, that can be applied in a variety of decorative and practical purposes.

### Ceramic Foam

Within the context of the present invention, the terms “ceramic foam”, “foamed ceramic”, “porcelain foam”, and “foamed porcelain”, are considered interchangeable. They should all be understood to relate to a macroporous foam wherein the solid phase comprises a ceramic material based on the cured clay composition of the invention.

### Clay Composition

Within the context of the present invention, the term “(ceramic) clay composition” or “foamable clay composition” is used to describe a plastic mixture comprising frit, plastic mineral clay, kaolin clay, alkali metal and/or alkaline earth metal salt and water in certain specified weight ratios. Optionally, the clay composition may comprise other solid materials, such as feldspar, mica and/or quartz, preferably in an amount of up to 25 wt %, more preferably up to 15 wt % by total weight of the clay composition. These other solid materials may fulfill various functions in the clay composition, such as providing whiteness, translucency or acting as a flux, i.e. lowering the melting temperature of the clay composition to which they are added.

### Frit

The clay composition of the invention comprises 40-75 wt %, preferably 50-70 wt %, more preferably 60-70 wt % of a frit. A frit is a vitreous composition that is commonly used in making porcelain, glass, glazes, and enamels. Frits are usually prepared by pre-measuring and mixing several raw ceramic materials, followed by melting, cooling and granulating. Typically, a frit comprises silica (SiO₂) and aluminum oxide (Al₂O₃) and a varying number of other metal oxide compounds selected from calcium oxide (CaO), sodium oxide (Na₂O), potassium oxide (K₂O), magnesium oxide (MgO), zinc oxide (ZnO), barium oxide (BaO), lead oxide (PbO), boron oxide (B₂O₃), titanium oxide (TiO₂), zirconium oxide (ZrO₂) and combinations thereof. Frits may be further identified by, e.g., their color, their main constituents, or their specific purpose in a manufacturing process, such as “blue frit”, “green frit”, “titanium (oxide) frit”, “glass frit” or “glaze frit”. Depending on the constituents and their concentrations, frit compositions exhibit distinct softening and melting temperatures (or trajectories), as well as viscosities associated with the molten state. Such softening/melting trajectories and viscosities are known in the art for a broad variety of frits and the skilled person will be able to define and select a frit composition that is appropriate for the envisaged process conditions and end product. In a preferred embodiment of the invention, the foamed ceramic structure according to the present invention is obtained by preparing a composition comprising a frit comprising silica (SiO₂) and sodium oxide (Na₂O) as major constituents. In another preferred embodiment, a frit comprising silica (SiO₂), sodium oxide (Na₂O), zinc oxide (ZnO), aluminum oxide (Al₂O₃), potassium oxide (K₂O), and calcium oxide (CaO) is applied. In a much preferred embodiment, the frit comprises 60-70 wt % SiO₂; 15-25 wt % Na₂O; 7-10 wt % ZnO; and 2-12 wt %, preferably 2-5 wt % each, of one or more compounds selected from Al₂O₃, K₂O, and CaO, all percentages based on the total weight of said frit. Particular good results are obtained using a frit comprising about 63 wt % SiO₂, about 19 wt % Na₂O, about 8.5 wt % ZnO, about 3.1 wt % Al₂O₃, about 2.8 wt % K₂O, and about 3.1 wt % CaO. Such a frit composition is commercially available from Ve-Ka Industrie Keramische Grondstoffen, Dreumel, The Netherlands, under the trade name Fritte 15.10.

### Kaolin Clay

The clay composition of the present invention comprises 5-25 wt %, preferably 6-20 wt %, more preferably 6-15 wt % kaolin clay. Kaolin clay is the primary ingredient of many ceramic and porcelain slip and clay compositions, and provides the ceramic foam of the present invention with its body. Kaolin clay, or just “kaolin”, is a soft white earth clay predominantly containing the mineral kaolinite, which is a hydrated aluminum silicate with the general formula Al₂Si₂O₅(OH)₄ or Al₂O₃.2(SiO₂).2(H₂O) reflecting the two water of crystallization molecules. In its natural state, however, it may be found with some of the alumina replaced by iron, titanium, and alkali metals. In the art, kaolin is also referred to “China clay”. Preferably, kaolin clay in powdered form is used.

### Plastic Mineral Clay

The clay composition further comprises 0.1-5 wt %, preferably 0.5-1.5 wt %, more preferably about 1 wt % of a plastic mineral clay. In the art, such plastic mineral clays are also referred to as “binder clay” or simply “binder”, as well as “clay-based rheology modifier”. The plastic mineral clay of the invention acts as a binder for the clay composition, and controls the viscosity, particularly upon the incorporation of substantial amounts of alkaline and/or alkaline earth metal salts. It may furthermore impart thixotropic properties to the clay composition and prevent syneresis (water separation). In a preferred embodiment of the invention, the plastic mineral clay comprise or consists of a clay from the smectite mineral group, more preferably hectorite and/or montmorillonite. Hectorite (a magnesium silicate) and montmorillonite (a magnesium aluminium silicate) are commonly obtained from bentonite ore, which mainly consists of smectite clays, and minor amounts of impurities such as gravel, shale and limestone; as such, hectorite- and montmorillonite based plastic clays are sometimes referred to as “bentonite clay” or “bentonite binder”. In another preferred embodiment, the plastic mineral clay comprises a mixture of hectorite and montmorillonite, preferably in a weight ratio between 1:0.5 and 1:50.

### Alkali Metal Salt, Earth Alkaline Metal Salt

The clay composition of the invention further comprises 10-30 wt %, preferably 12-25 wt %, more preferably 14-20 wt %, based on the total weight of the dry compounds, of one or more alkali metal salts and/or alkaline earth metal salts. In one embodiment, the composition contains both one ore more alkali metal salts and one or more alkaline earth metal salts. Such salts may be the hydroxyl (OH), carbonate (CO₃²), bicarbonate (HCO₃⁻), sulphate (SO₄²⁻), oxalate (C₂O₄⁻), hydrogen oxalate (HC₂O₄⁻) or phosphate (PO₄³⁻) salts of the alkaline earth metals magnesium (Mg²⁺), calcium (Ca²⁺), strontium (Sr²⁺), barium (Ba²⁺), preferably of magnesium (Mg²⁺) or calcium (Ca²⁺), or mixed salts thereof, such as hydroxyapatite (Ca₁₀(PO₄)₆(OH)₂; sometimes also denoted Ca₅(PO₄)₃(OH)). The alkali metal salts according to the invention comprise the hydroxyl, carbonate, sulphate, oxalate, hydrogen oxalate or phosphate salts of lithium (Li⁺), sodium (Na⁺) or potassium (K⁺), or mixed salts thereof. Preferred alkali metal salts and/or alkaline earth metal salts for use in the clay composition of the invention are hydroxyapatite (Ca₁₀(PO₄)₆(OH)₂), calcium phosphate, calcium carbonate, calcium sulphate, magnesium carbonate, magnesium sulphate, magnesium phosphate, calcium hydroxide, magnesium hydroxide, sodium hydroxide, sodium carbonate, sodium oxalate, calcium oxalate, potassium hydroxide, potassium carbonate, potassium hydrogen oxalate, lithium carbonate, more preferably hydroxyapatite, calcium phosphate, calcium carbonate, magnesium carbonate, magnesium sulphate, magnesium phosphate, calcium hydroxide, magnesium hydroxide, sodium hydroxide, sodium oxalate, calcium oxalate, potassium hydroxide, potassium carbonate, potassium hydrogen oxalate, and mixtures thereof. Preferably, alkaline earth metal salts are used. Particularly preferred alkaline earth metal salts are calcium phosphate (Ca₃(PO₄)₂) and hydroxyapatite (Ca₁₀(PO₄)₆(OH)₂).

The alkali metal salts and alkaline earth metal salts of the invention have in common that during firing of the clay composition of the invention of which they form part, they partially or fully decompose under the formation of volatile gases, which become at least partially entrapped in the liquefied clay composition that results from melting of the frit also present in said clay composition. Depending on the nature of the anionic species in the alkali metal or alkaline earth metal salts of the invention, these gaseous components may comprise water (H₂O), carbon monoxide (CO), carbon dioxide (CO₂) and sulphur dioxide (SO₂). Generally, (partial) decomposition of the alkali metal and alkaline earth metal salts of the invention is brought about in the temperature range of 700-1700° C., which is relatively higher than the melting temperatures or trajectories of common frits, which lie in the temperature range of 500-1200° C. Hence, the effect of the invention is best obtained when the frit is in its softened or molten state before (partial) decomposition of the alkali metal or alkaline earth metal salts of the invention commences. It is within the competence of the skilled person seeking to prepare a foamable ceramic clay composition according to the invention to select, starting from a certain fit with known softening/melting temperature, one or more alkali metal or alkaline earth metal salts that have a (partial) decomposition temperature that is higher than said softening/melting temperature. The difference between the (partial) decomposition temperature of the alkali metal or alkaline earth metal salts and of the softening/melting temperature of the frit of the invention may be within the range of 50° C. to 1000° C., preferably between 50° C. and 700° C., more preferably between 50° C. and 500° C., most preferably between 50° C. and 250° C.

### Preparation of Foamable Clay Composition

According to the invention, 5-25 wt % kaolin clay, 10-30 wt % alkali metal salt and/or alkaline earth metal salt and 40-75 wt % frit, and optionally other solid components, such as feldspar, are dry mixed in a standard blunger. To this mixture is then added 0.1-5 wt %, preferably 1 wt %, based on the total weight of the dry components, of the plastic mineral clay (“binder”), and 10-50 wt % water, based on the weight of the dry components, until the mass has a moldable clay-like substance that does not stick to its surroundings and remains intact when hand-formed balls of the clay composition are thrown up in the air.

The density of the clay composition is typically in the order of 1.5-2 kg/liter. The present invention also relates to a heat-foamable clay composition, comprising
i) 5-25 wt % kaolin clay;
ii) 10-30 wt % of one or more alkali metal salts and/or alkaline earth metal salts;
iii) 0.1-5 wt % plastic mineral clay; and
iv) 40-75 wt % frit;
   wherein all weight percentages are based on the total weight of solids;
and 10-50 wt % water, based on the total weight of solids.

In a particularly preferred embodiment of the invention, the foamable clay composition comprises 7-9 wt % powdered kaolin clay, 7-9 wt % feldspar, 15-17 wt % alkali metal salt and/or alkaline earth metal salt, 0.5-1.5 wt % plastic mineral clay and 60-70 wt % frit, as well as 15-25% water, based on the total weight of kaolin clay, feldspar, alkali metal salt and/or alkaline earth metal salt, plastic mineral clay and frit.

### Shaping

Shaping of the resulting clay composition is performed by transferring the clay composition as prepared into a mould and equally distributing the clay composition mass over the inside cavity of the mould. Various shapes and dimensions of the moulds are possible. The clay composition is generally applied in a layer with an average thickness between 0.5 and 5 cm, preferably about 2 cm. Suitable moulds for the present invention are known to those skilled in the art. Good results have been obtained using moulds prepared of equal amounts (w/w) of plaster, quartz and water. Release agents that are already known in the art may be used, including aluminum oxide or quartz/plaster mixtures.

### Temperature Treatment

The present invention further relies on subjecting the ceramic clay composition to a specific temperature treatment, also referred to in the art as “heating curve”, comprising a drying and a firing step and optionally a temperature maintaining step, which serve to remove water, burn out organic matter, effectuate cavity formation and hardening of the resulting porcelain matrix surrounding the cavities, and if a glaze is applied the sintering of said glaze onto the ceramic, into a dense, strong ceramic matrix. These steps are suitably performed in a ceramic kiln with computer control of the heating rate and temperature.

The objective of the invention is attained by treating the clay composition of the invention in the mould, i.e. the “shaped clay composition”, to a drying step at a temperature equal to or higher than room temperature, preferably higher than 50° C., more preferably higher than 100° C. and lower than 140° C., preferably lower than 130° C., followed by firing at a temperature between 700-1200° C. and optionally maintaining said shaped composition in said mould at or around the firing temperature during at most 6 hours. Drying of the shaped clay composition may be performed during a period of anything between 1 hour, preferably 2 hours and several days, preferably 2 days (48 hours). Typically, a drying period of 3 hours is applied. It is possible to gradually increase the temperature from room temperature to said maximum temperature of 140° C. during the aforementioned period of between 1, preferably 2 hours and several days, or to apply a number of consecutive drying steps at increasing fixed temperatures. “Drying” within the context of the present invention is understood to imply removing the moisture, predominantly water, from the clay composition to a rest value of about 5 wt %, preferably 1 wt % based on total weight of the clay composition. It lies within the general expertise of the skilled person to choose the optimum drying time and temperature for the particular combination of clay composition, mould and dimensions of the shaped clay composition, as well as adapt these to the humidity levels of the surroundings and air circulation conditions of the kiln.

Firing of the shaped clay composition is performed at a temperature between 700-1200° C., preferably between 800 and 1000° C., more preferably between 850 and 950° C. Firing time of the shaped clay composition depends on the size, shape and filling level of the foamable composition and may be performed during a period of anything between 4 hours and 4 days, preferably 4-12 hours, more preferably 6-10 hours. Again, it lies within the general expertise of the skilled person to choose the optimum firing time and temperature for the particular combination of clay composition, mould and dimensions of the shaped clay composition as well as kiln type. “Firing” within the context of the present invention is understood to involve a temperature treatment resulting in the removal of organic residues, softening or melting of the frit and the (partial) decomposition of part of the constituents of the clay composition of the invention, particularly of the alkali metal salt and/or alkaline earth metal salt, resulting in the formation of gaseous compounds, which results in the entrapment of gas bubbles in the viscous liquid clay composition, followed by fixation of the ensuing foamed structure by hardening of the ceramic material. The firing temperature should be chosen such that both gas formation by (partial) decomposition and melting of the frit are realized. Hence, in a preferred embodiment of the invention, the firing temperature is equal to or higher, preferably at most 150° C. higher, more preferably at most 100° C. higher, most preferably at most 50° C. higher, than the (partial) decomposition temperature of the alkali metal or alkaline earth metal salts according to the invention. For example, using a clay composition comprising a frit comprising about 63 wt % SiO₂, about 19 wt % Na₂O, about 8.5 wt % ZnO, about 3.1 wt % Al₂O₃, about 2.8 wt % K₂O, and about 3.1 wt % CaO, which softens at about 650 degrees, and hydroxyapatite (Ca₁₀(PO₄)₆(OH)₂) as the alkaline earth metal salt, which releases gaseous H₂O by dehydroxylation to form oxyhydroxyapatite (Ca₁₀(PO₄)₆(OH)₂₋₂ₓOₓ) at about 800° C., firing is preferably performed between 850-950° C., more preferably at around 850° C. at around 900° C. Firing may involve gradually increasing the temperature over a certain period of time without reaching a constant temperature, provided the final temperature within the range of 700-1200° C. is sufficiently high to realize softening of the frit and gas formation and entrapment.

Firing may also be performed by performing a number of consecutive firing steps at increasing fixed, i.e. plateau, temperatures. In some cases, it is preferred to maintain the temperature within a range of 50° C. below and 50° C. above the highest temperature applied in the firing step for some time, for at least 10 minutes, preferably for at least 30 minutes, more preferably at least 45 minutes, most preferably at least 1 hour, and for at most 6 hours, more preferably at most 4 hours, most preferably at most 2 hours. This temperature maintaining step serves to allow the endothermic melting and (partial) decomposition reactions to occur throughout the entire bulk of the foamable clay composition, especially in larger shaped objects. After firing and optionally maintaining at the firing temperature, the shaped foamed article is allowed to cool to room temperature during a sufficiently long time. This is a well known process in the art of ceramics and the skilled man will be able to provide the required measures to cool the ceramic foam structure without damaging its structure.

### Foam Structure

Solid foams can be classified into two types based on their pore structure: open cell structured foams and closed cell foams. Open cell structured foams contain pores that are connected to each other and form an interconnected network that will fill with the surrounding medium, e.g. water and is generally relatively soft. Closed cell foams on the other hand do not have interconnected pores. Closed cell structure foams have higher dimensional stability, low moisture absorption coefficients and higher strength compared to open cell structured foams.

The porous ceramic according to the present invention is characterized by having a closed cell structure and good buoyancy characteristics. It displays a variety of pore or ‘bubble’ sizes, with an average pore size typically ranging from about 1 to about 5 millimeters. The bubble size can to some extent be controlled by the process conditions. For example, by cautious choice of the heating rate, heating time, wall thickness of the mould and thickness of the layer of clay composition in the mould it is possible to obtain various pore shapes and sizes.

In a preferred embodiment of the invention, the percentage of expansion of the final structure is 300-500%, more preferably 350-450%, as compared to the original volume of the clay composition after transfer to the mould. This corresponds to a density of the foamed ceramic in the order of 0.3-0.4 g/cm³.

The foamed porcelain-type ceramic is further characterized by being fireproof and thermally insulating. This renders the material very suitable for application in construction materials, which will be discussed further below.

The term ‘pores’ or ‘cells’ within the context of the present invention should be distinguished from the microscopic, invisible to the human eye, cavities that may be present in the solid porcelain matrix, which are about three orders of magnitude smaller than the bubbles making up the foam-like structure according to the present invention.

### Glazing

Preferably, the ceramic foam according to the invention is glazed, which serves to provide the ceramic foam with surface strength. In a preferred embodiment of the invention, the outer layer of the ceramic foam is glazed using a mixture comprising a frit and clay, wherein the weight ratio of frit to clay is between 3:2 and 9:1, said composition further comprising 10-60 wt % water, based on the total weight of frit and clay. Contrary to the foamable clay composition of the invention, this glazing composition should be sufficiently liquid, i.e. sprayable, brushable or pourable. The glazing composition is applied by brushing, spraying or pouring it into the mould prior to introducing the foamable clay composition. Subsequently, the glazing composition and the foamable clay composition are subjected simultaneously to the same temperature treatment of the invention. The frit applied in the glazing composition may be the same frit as applied in the foamable clay composition, or be different. In a preferred embodiment, the frit applied in the glazing composition comprises 60-70 wt % SiO₂, 15-25 wt % Na₂O, 7-10 wt % ZnO, 2-5 wt % Al₂O₃, 2-5 wt % K₂O, 2-5 wt % CaO, based on the total weight of the frit. More preferably said frit comprises about 63 wt % SiO₂, about 19 wt % Na₂O, about 8.5 wt % ZnO, about 3.1 wt % Al₂O₃, about 2.8 wt % K₂O, and about 3.1 wt % CaO. Such a frit composition is commercially available from Ve-Ka Industrie Keramische Grondstoffen, Dreumel, The Netherlands, under the trade name Fritte 15.10. Good result have been obtained, for example, using a clay available as ‘VM 545’ from the European Ceramic Workcentre (EKWC), Den Bosch, The Netherlands, comprising 57.3 wt % SiO₂, 1.7 wt % Na₂O, 37.5% wt % Al₂O₃, 0.04 wt % TiO₂, 0.2 wt % Fe₂O₃, 0.33 wt % MgO, 0.77 wt % CaO and 2.1 wt % K₂O.

### Color and Transparency

The porcelain foam of the invention as such is further characterized by having a transparent white appearance. It is possible however to provide the porcelain foam with any desired color. In one embodiment, this can be achieved by admixing a suitable pigment to the glazing composition. In another embodiment, the pigment is added during the dry mixing stage of preparing the foamable clay composition. Pigments for use in ceramics in general and in ceramic glazes are well known in the art, and the skilled person will be able to suitably select the pigment and determine the amount required of said pigment.

### Applications

The invention furthermore pertains to the ceramic foam or foamed porcelain obtainable by the process according to the invention. Although the foamed porcelain according the invention can be applied for a wide variety of decorative purposes, such as macroporous ceramic bowls and kitchenware, it is emphasized that the process and the ceramic foam according to the invention should not be understood to be limited to ornamental or decorative purposes only. In a preferred embodiment, the foamed porcelain is used in a construction material. In a particularly preferred embodiment, the process according to the invention is applied in the preparation of a construction material substantially comprising ceramic foam, such as a foam porcelain brick or tile. In another preferred embodiment, a piece of sanitary ware comprising the foamed ceramic material of the invention is provided. Accordingly, the invention pertains to a shaped article comprising, preferably comprising for at least 50 wt %, more preferably at least 90 wt %, or consisting of the the porous ceramic foam according to the invention, said shaped article preferably being a construction material, such as building brick, insulation brick, wall tile, floor tile or sanitary ware.

### EXAMPLES

The invention is now demonstrated by the following non-limiting examples.

### Example 1

### Preparation of a Foamable Clay Composition

A foamable clay composition was prepared comprising

| | | |
|---|---|---|
| Fritte 15.10 | 66 | wt % |
| Kaolin | 8.3 | wt % |
| Hydroxyapatite | 16.5 | wt % |
| Feldspar | 8.3 | wt % |
| Plastic mineral clay (Bentone) | 1.0 | wt % |

All ingredients were obtained from Keramikos, Haarlem, The Netherlands. The ingredients were mixed during 15 minutes in a standard blunger at about 200 rpm under ambient conditions. Subsequently, about 20 wt %, based on the total weight of the solid material, tap water was added under continuous stirring until a non-sticking, plastic clay-like mass was obtained. The proper amount of water added was checked by manually forming a ball from the clay mass and throwing it in the air, whereupon it is supposed to not stick to the hands and stay one mass.

### Example 2

### Preparation of Foamed Porcelain

The foamable clay composition according to Example 1 was transferred to brick-shaped mould having inner dimensions of 18.0×10.0×22.0 cm and applied in a layer of about 4 cm thickness. The mould containing the foamable clay composition was then subjected, under ambient air conditions in a computer-controlled kiln, to drying at 120° C. during 5 hours. Subsequently, the temperature was raised during 10 hours to a final temperature of 900° C., which temperature was maintained during 2 hours. The composition was then allowed to cool in the mould during 16 hours to room temperature. This resulted in the formation of a brick-shaped porcelain-type ceramic material, having a transparent white color, a closed cell structure substantially comprising 1-5 mm-sized pores and a density of about 0.35 kg/dm³.

1-15. (canceled)

16. A method for the preparation of a ceramic foam, comprising:
(a) shaping in a mould a clay composition comprising, based on the total weight of solids:
(i) 5-25 wt % kaolin clay;
(ii) 10-30 wt % of one or more alkali metal salts and/or alkaline earth metal salts;
(iii) 0.1-5 wt % plastic mineral clay;
(iv) 40-75 wt % frit; and
(v) 10-50 wt % water, based on the total weight of solids;
(b) drying the composition under temperatures below 140° C.; and
(c) firing the composition at temperatures between 700-1200° C.

17. The method according to claim 16, further comprising:
(d) heating the composition to temperatures between 50° C. below the highest temperature and 50° C. above the highest temperature reached in step (c), for 10 minutes to 6 hours.

18. The method according to claim 16, wherein the alkali metal salt and/or alkaline earth metal salt at least partially decomposes under the formation of gaseous compounds at a temperature that is equal to or higher than the melting temperature of the fit.

19. The method according to claim 16, wherein the temperature in step (c) is equal to or higher than the decomposition or partial decomposition temperature of the alkali metal salt and/or alkaline earth metal salt.

20. The method according to claim 16, wherein the alkaline earth metal is chosen from the group consisting of magnesium, calcium, barium and strontium.

21. The method according to claim 20, wherein the alkaline earth metal is chosen from the group consisting of magnesium and calcium.

22. The method according to claim 16, wherein the alkaline earth metal salt is hydroxyapatite.

23. The method according to claim 16, wherein the alkali metal is chosen from the group consisting of lithium, sodium and potassium.

24. The method according to claim 16, wherein the plastic mineral clay is hectorite or montmorillonite, or a combination thereof.

25. The method according to claim 24, wherein the plastic mineral clay comprises hectorite and montmorillonite in a weight ratio between 1:0.5 and 1:50.

26. The method according to claim 16, wherein the fit comprises 60-70 wt % 15-25 wt % Na₂O, 7-10 wt % ZnO, 2-5 wt % Al₂O₃, 2-5 wt % K₂O, 2-5 wt % CaO

27. The method according to claim 16, further comprising applying a glaze-forming composition in the mould prior to shaping of the clay composition, the glaze-forming composition comprising a fit and clay, wherein the weight ratio of fit to clay is between 3:2 and 9:1, the glaze-forming composition further comprising 10-60 wt % water, based on the total weight of frit and clay.

28. A ceramic foam obtainable by the process according to claim 16.

29. Shaped article comprising the porous ceramic foam according to claim 28.

30. The article according to claim 29, being a construction material.

31. The article according to claim 30, wherein the construction material is a building brick, insulation brick, wall tile, floor tile or sanitary ware.

32. A heat-foamable composition, comprising, based on the total weight of solids:
(i) 5-25 wt % kaolin clay;
(ii) 10-30 wt % of one or more alkali metal salts and/or alkaline earth metal salts;
(iii) 0.1-5 wt % plastic mineral clay;
(iv) 40-75 wt % frit; and
(v) 10-50 wt % water, based on the total weight of solids.
